(19) United States
(12) Patent Application Publication
(10) Pub. No.: US 2024/0010040 A1
(43) Pub. Date: Jan. 11, 2024

(54) TOP MOUNT ASSEMBLY OF A MOTOR VEHICLE SUSPENSION STRUT, AND SUSPENSION STRUT COMPRISING SUCH AN ASSEMBLY

(71) Applicant: NTN EUROPE, Annecy (FR)

(72) Inventors: Alexandre BAUDU, Annecy (FR); Vincent POURROY-SOLARI, Thônes (FR)

(73) Assignee: NTN EUROPE, Annecy (FR)

(21) Appl. No.: 18/347,649

(22) Filed: Jul. 6, 2023

(30) Foreign Application Priority Data
Jul. 7, 2022 (FR) 2206987

(51) Int. Cl. B60G 15/02; B60G 13/00

(52) U.S. Cl. CPC B60G 15/02; B60G 13/003; B60G 2204/128; B60G 2204/1242; B60G 2206/73; B60G 2202/12

(57) ABSTRACT

The invention relates to a top mount assembly of a suspension strut, the assembly comprising: a bearing and a filtering sub-assembly abutting the bearing, which includes: a filter block; a lower support having a central portion abutting a lower face of the filter block and a peripheral portion; a cover including a central portion abutting an upper face of the filter block and a peripheral portion abutting the annular peripheral portion of the lower support. The peripheral portion of the cover is provided with fastening openings arranged radially outside the bearing to secure the filtering sub-assembly to a body element of the vehicle.

### CROSS-REFERENCE TO RELATED APPLICATIONS

This application claims the benefit of priority under 35 U.S.C. 119 to French Patent Application No. 2206987, filed Jul. 7, 2022; the disclosure of which is incorporated herein by reference in its entirety.

### FIELD

The invention relates, in general, to the technical field of motor vehicle suspensions.

The invention relates more specifically to a top mount assembly of a motor vehicle suspension comprising a filtering sub-assembly, and to a suspension strut incorporating such a mount assembly.

### BACKGROUND

Motor vehicle suspension struts comprising a coil spring wound around a telescopic damper are connected to the body of the vehicle at a multi-functional interface, referred to as the suspension top mount, which in particular integrates functions of fastening to the body, rotationally guiding the upper end of the coil spring and/or of the suspension strut during rotation while the wheels are being steered, holding the rod of the telescopic damper, where appropriate with vibratory filtration, and bearing a shock pad at the end of travel of the body of the telescopic damper. Such a mount requires a large number of parts, some of which can be preassembled before mounting on the vehicle, and others must be assembled at the time of attachment to the vehicle.

An example of a suspension strut top mount of the preceding type is given by the document EP1591691A1. This mount comprises a rolling bearing comprising an upper washer, a lower washer and balls circulating on raceways formed on the upper and lower washers, as well as a rigid multifunctional part consisting of a stamped sheet and an elastomeric filter block positioned between the upper washer and the multifunctional part. The multifunctional part comprises a plurality of fastening holes, each opening onto a bearing wall turned downward. Nuts are welded to the multifunctional part at the support walls, in the extension of the fastening holes. It is thus possible to secure the top mount to the body of the vehicle using screws which pass through the fastening holes and are screwed into the nuts. Before it is mounted on the vehicle, the mount does not form a coherent whole. Precautions must also be taken to protect the metallic multifunctional part against corrosion.

The suspension strut top mount assembly shown in document DE 10-2009-059 168 A1 differs from the preceding one in particular by the fact that the multifunctional part is made of molded plastic material and has threaded metal inserts at the fastening holes. Such a part is potentially lighter than a sheet metal part, and is relatively insensitive to corrosion, except at the metal inserts. The manufacture of the multifunctional part in an injection mold with its overmolded metal inserts in practice leads to a low plastic resistance with respect to impact damping forces.

Document FR 3-112-101 A1 describes a suspension strut top mount assembly that minimizes the final mounting steps on the vehicle, but remains compatible with high production rates. This configuration is offered by fastening interfaces on the multifunctional part each comprising an open fastening slot on a peripheral wall on the multifunctional part and each configured to receive at least a portion of a fastening element in a direction inclined relative to the axis of fastening of the rod, the arrangement of the slits guaranteeing that the fastening elements will not escape from the slits during assembly. The configuration described in this document makes it possible to avoid a step of permanently fastening the fastening elements to the multifunctional part, in particular by welding or overmolding, before mounting on the vehicle.

The document JP2010014133 describes a filtering sub-assembly for a non-steering suspension strut of a motor vehicle, which comprises a prestressed filter block between a lower support and a cover, as well as fastening elements passing through the lower support and the cover to ensure on the one hand the fastening of the support less than the cover and the prestress of the filter block before mounting on the vehicle, and then the fastening of the assembly to a motor vehicle body element. Such a device requires dual-function fastening studs, the head of which forms a rivet for fastening the support lower than the cover, and the body of which has a thread for a nut positioned on the upper side of the body element of the vehicle. This architecture is not suitable for a steering wheel suspension strut that requires a sliding or rolling bearing interposed between the filtering sub-assembly and the spring of the suspension strut.

A similar assembly is proposed in document EP1564037A2, but with simple screw fastening elements, which allow the filter block to be stressed only at the time of the fastening of the assembly to the vehicle.

Document DE102014218800A1 discloses a filtering sub-assembly for a motor vehicle suspension strut, which comprises a filter block arranged without prestressing between a lower support and a cover, as well as snap-fastening elements between the lower support and the cover, and fastening screws for fastening the cover to a vehicle body element. However, this device is not designed to integrate a bearing.

### SUMMARY

The invention aims to propose a top mount assembly of a motor vehicle suspension strut, comprising a sliding or rolling bearing and a filtering sub-assembly whose filter block can be preloaded before mounting on the vehicle.

To do this, according to a first aspect of the invention, a top mount assembly of a motor vehicle suspension strut, the assembly comprising: a sliding or rolling bearing and a filtering sub-assembly in direct or indirect abutment against the bearing, the bearing defining an axis of rotation, the filtering sub-assembly comprising:
a filter block made of elastomeric material, the filter block extending along a reference axis and having an interface for securing one end of a rod of a damper of the suspension strut;
a filter block lower support located between the filter block and the bearing and having an annular central portion abutting a lower face of the filter block and traversed axially by a passage for the end of the damper rod, the filter block lower support having an annular peripheral portion surrounding the central portion, the filter block lower support further having an upper face facing the filter block and an opposing lower face for a shock pad of the suspension;
a filter block cover comprising a central portion abutting an upper face of the filter block, a peripheral portion surrounding the central portion and abutting the annular peripheral portion of the lower support, the peripheral portion of the cover being provided with fastening openings arranged radially outside the bearing and configured to fasten the filtering sub-assembly to a body element of the motor vehicle; and
fastening means that secure the cover to the filter block lower support independently of the fastening openings, the filter block being prestressed between the lower support and the filter block cover.

The assembly allows the cover to be fastened to the lower support by the fastening means independently of the fastening of the cover to the vehicle body, which calls for fastening elements inserted into the fastening openings. The positioning of the fastening openings outside the bearing releases a volume that makes it possible to accommodate the bearing.

Preferably, the fastening openings are arranged radially outside the filter block lower support.

According to one embodiment, the filter block lower support has:
a cylindrical skirt configured to be fitted in an adjusted manner with a cylindrical portion of an intermediate support part or a bearing of the assembly; and
an outer transverse shoulder for abutting an upper face of said intermediate support part or of the bearing of the assembly.

According to one embodiment, the filter block lower support is made of a single piece of metal.

According to one embodiment, the filter block cover is made of plastic material(s), where appropriate with reinforcements or inserts.

According to one embodiment, the fastening means for securing the cover with the filter block lower support comprise:
at least one flap for fastening the lower support protruding from the annular peripheral portion of the lower support; and
at least one fastening orifice on the peripheral portion of the cover associated with the fastening flap of the lower support and crossed by a proximal portion of the associated fastening flap in an axial direction, a distal portion of the associated fastening flap extending at least along a component perpendicular to the axial direction overlapping with a mating surface on one side of the cover opposite the peripheral portion of the lower support to ensure the fastening of the cover with the lower support block support.

According to one embodiment, each fastening flap of the fastening means to ensure the fastening of the cover with the filter block lower support is crimped against the cover on the cover side opposite the filter block to secure the cover with the filter block lower support. Thus, fastening flaps are obtained whose distal portion is bent relative to the proximal portion, this bending being obtained by a crimping method. Preferably, in the case of a plurality of fastening flaps, the set of fastening flaps is crimped.

Alternatively, and according to another embodiment, the fastening means for securing the cover with the filter block lower support comprise a lock washer, a first element from the lower support and the cover being located axially between the lock washer and a second element from the lower support and the cover, flaps and notches being formed on the lock washer and the second element, each of the flaps formed on one piece from the lock washer and the second element being associated with one of the notches, formed on another part of the lock washer and the second element, the lock washer being movable relative to the second element between:
a relative approach position and a relative position of interpenetration by relative translational movement between the lock washer and the second element along the reference axis such that, in the relative interpenetration position, each of the fastening flaps penetrates into the associated notch,
the relative interpenetration position and a relative assembly position by relative rotational movement between the lock washer and the second element about the reference axis such that in the relative assembly position, each of the fastening flaps is housed in a circumferential extension of the associated notch and is axially retained in axial abutment against a rim of the associated notch.

According to one embodiment, the fastening means for securing the cover with the filter block lower support comprise at least one fastening per thread.

According to one embodiment, the peripheral portion surrounds the lower support.

The axis of rotation defined by the bearing may intersect with the reference axis, or parallel to the reference axis, in particular coincident with the reference axis.

According to one embodiment, the top mount assembly comprises a rigid intermediate support part that abuts the bearing and that forms a support cradle supporting the filtering sub-assembly.

According to one embodiment, the top mount assembly further comprises an annular bearing support forming a mating face for a coil spring of the suspension, the mating face facing away from the bearing, the intermediate support part and the bearing support defining together at least part of an annular volume for the bearing.

According to one embodiment, the filter block cover forms an outer protective skirt located radially outside and at least partially opposite an outer peripheral face of the bearing support to delimit a sealing zigzag. Preferably, the zigzag provides a resilient attachment of cohesion between the bearing support and the cover before mounting on the body element of the motor vehicle.

According to one embodiment, the intermediate support part or the bearing support comprises an inner skirt positioned radially inside the bearing, the inner skirt preferably comprising a hooking shape for an upper end of the shock pad.

The invention also relates to a suspension strut for a motor vehicle, comprising a coil spring, a telescopic damper, and a shock pad, remarkable in that it further comprises a top mount assembly as described above.

### BRIEF DESCRIPTION OF THE DRAWINGS

Other features and advantages of the invention will become apparent on reading the following description, with reference to the appended figures, which show:

FIG. 1 is a sectional view of a top part of a motor vehicle suspension strut, and of a suspension top mount assembly of this suspension strut, according to a first embodiment;

FIG. 2 is an isometric perspective view of the assembly FIG. 1;

FIG. 3 is an isometric and exploded perspective view of a top part of a motor vehicle suspension strut, and of the suspension top mount assembly of this suspension strut, according to a second embodiment;

FIG. 4 is a sectional view of the top part of the motor vehicle suspension strut, and of the suspension top mount assembly of this suspension strut, according to a second embodiment;

FIG. 5 is a sectional view of an isometric perspective of the suspension top mount assembly of this suspension strut according to this second embodiment before fastening the lower support to the cover;

FIG. 6 is a sectional view of an isometric perspective of the suspension top mount assembly of this suspension strut according to this second embodiment wherein fastening flaps of the lower support pass through associated fastening orifices of the cover in the free position, before crimping;

FIG. 7 is a cross sectional view of an isometric perspective of the suspension top mount assembly of this suspension strut according to this second embodiment, wherein the fastening flaps are crimped against the cover on the cover side opposite the filter block to secure the cover to the lower support block support;

FIG. 8 is a view of the lower support according to this second embodiment, before crimping the fastening flaps;

FIG. 9 is a view of the lower support of FIG. 8, after crimping the fastening flaps;

FIG. 10 is a view of an alternative embodiment of a lower support suitable for this second embodiment, before crimping the fastening flaps;

FIG. 11 is a view of the lower support of FIG. 10, after crimping the fastening flaps.

For greater clarity, identical or similar elements are identified by identical reference signs in all of the Figures.

### DETAILED DESCRIPTION

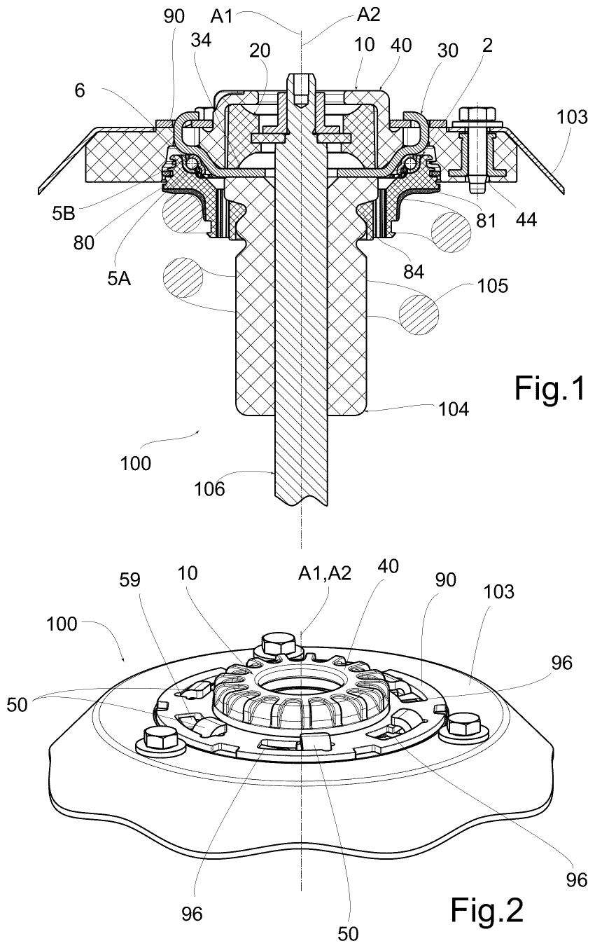

FIG. 1 shows he upper part of a suspension strut, bearing on a vehicle body element 103, in this case in the form of an inverted frustoconical bowl. The suspension strut comprises a coil spring 105, a telescopic damper 106 located inside the coil spring 105, and a suspension top mount assembly 100, providing an interface between the body 103 on the one hand, and the coil spring 105 and the telescopic damper 106 on the other hand.

The top mount assembly 100, also shown in FIG. 2, comprises a bearing 2 resting on an annular bearing support 80 based on a spring filtration element itself resting on the upper turn of the coil spring 105, and a shock pad 104. The assembly 100 comprises an attachment part, placed radially inside the bearing support 80, this attachment part comprising an inner skirt 84 furthermore positioned radially inside the bearing 2, the inner skirt 84 comprising a hooking shape for an upper end of a protective bellows (not shown) of the damper 106.

The top mount assembly 100 furthermore comprises a filtering subassembly 10 also forming a cover of the bearing 2, the filtering sub-assembly 10 forming a filter block 20 made of elastomeric material located radially and axially within the filtering subassembly 10, a rigid single-piece lower support 30 of the filter block 20, the lower support 30 being located between, in particular, interposed between, the filter block 20 and the bearing 2, and a cover 40 of the filter block 20.

The bearing 2 has the function of allowing the upper turn of the coil spring 105 to rotate when the coil spring 105 contracts and relaxes, or when the wheels are being steered, by rotationally guiding the bearing support 80 about a rotation axis A2. The bearing 2 is here a rolling bearing and comprises a lower washer 4 made of stamped sheet metal, an upper washer 5 made of stamped sheet metal defining the axis of rotation A2 and rolling bodies 6, in this case balls, rolling on raceways 7, 8 formed on the lower 4 and upper 5 washers to rotationally guide the lower washer 4 relative to the upper washer 5 about the axis of rotation A2. The rolling bearing 2 is oblique-contact, and the rolling bodies 6 are in contact with a radially outer area of the raceway 8 of the upper washer 5 and with a radially inner area of the raceway 7 of the lower washer 4, the inner area being radially inside the outer area, relative to the axis of rotation A2. The balls are separated and kept approximately equidistant using a cage 6′.

The suspension strut is oriented in such a way that the assembly 100 is largely located “under” the body 103 and the coil spring 105 is at least partially located “under” the assembly 100.

The annular bearing support 80 can be made for example of plastic, or of metal alloy, for example made of aluminum injected under pressure, with or without a reinforcing insert, and forms a planar annular mating face turned axially relative to the axis of rotation A2, opposite the bearing 2, as well as a cylindrical guide face turned radially outwards.

The filter block support 30 and bearing support 80 together delimit a confined annular volume for the bearing 2. The filter block cover 40 itself forms an outer protective skirt 49 located radially outside and at least partially opposite an external peripheral face 82 of the bearing support 80.

The filter block 20 is formed of elastomeric material and extends along a reference axis A1, the filter block 20 having a interface 21 for securing one end of a telescopic damping rod 102 of the suspension strut 106, which passes through a lumen formed in the shock pad 104 and a passage 33 of the support 30.

The filter block support 30 may be made of a metal alloy, for example made of steel or aluminum injected under pressure, and preferably a single piece, i.e. one piece. Preferably, the support 30 is made of steel, from a stamped sheet. The filter block support 30 comprises a wall 34 having an upper face 35 facing the filter block and an opposite lower face 36 mating with a shock pad 104 of the suspension. More precisely, the filter block support 30 has an annular central portion 31 abutting a lower face 22 of the filter block 20 and passing axially through the passage 33 for the end of the damping 106 rod 102, the lower support 30 having an annular peripheral portion 32 surrounding the annular central portion 31.

In this embodiment, the rigid one-piece support 30 of the filter block 20 is formed by a stamped sheet that forms a housing bowl of the filter block 20, disposed radially inside the bearing 2, in radial contact with said bearing 2, and a collar surrounding the bowl, placed on the bearing 2. More precisely, the filter block lower support 30 has a cylindrical skirt 39A configured to fit in an adjusted manner with a cylindrical portion 5A of the assembly 100 bearing 2 and an outer transverse shoulder 39B to abut an upper face 5B of said bearing 2 so that the filtering sub-assembly 10 is directly abutting the bearing 2.

The cylindrical skirt 39A and outer transverse shoulder 39B are carried by an intermediate annular portion 312 connecting the annular central portion 31 and the annular peripheral portion 32 between them, the cylindrical skirt 39A forming a cylindrical centering portion and transverse shoulder 39B forming a direct or indirect planar mating portion for the bearing 2.

The bowl housing the filter block 20, has a bottom 35 constituting an intermediate wall between the filter block 20 and the shock pad 104. A lower face of this intermediate wall is a support for the shock pad 104 of the suspension. The upper face of the intermediate wall is in contact with the filter block 20, the bottom 35 receiving the filter block 20 in axial abutment against a lower face 22 of said filter block 20.

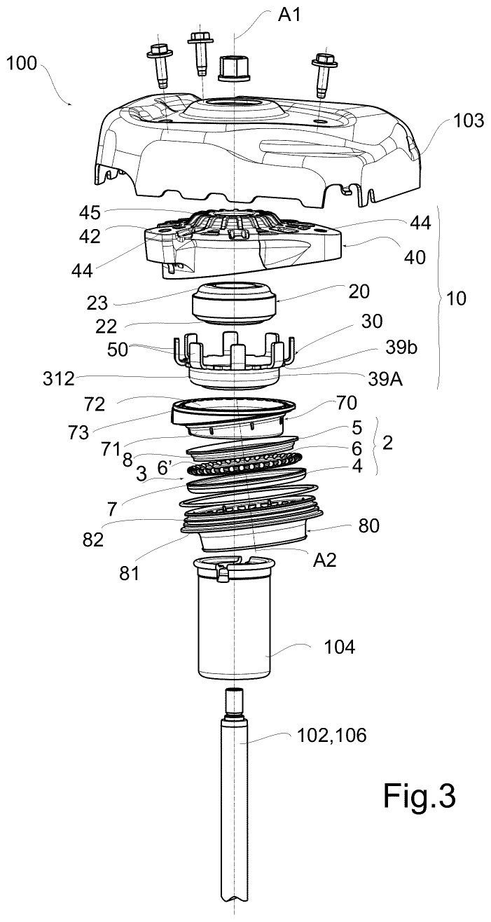

The support 30 filter block, in particular here the metal sheet constituting the rigid one-piece support 30 is annular and the bottom 35 of the bowl has a circular opening forming the passage 33 for the end of the rod 102 of the telescopic damper 106. The filter block support 30 has a rotational symmetry about the reference axis A1 which also corresponds to a reference axis for the telescopic damper 106 in its reference position, the shock pad 104 and the filter block 20. This axis of symmetry A1 is here parallel, and coincident, with the axis of rotation A2 of the bearing 2, although other configurations are conceivable, in particular a configuration wherein the reference axis A1 intersects the axis of rotation A2 of the bearing 2 (see for example the embodiment shown with reference to FIG. 3).

The filter block cover 40 makes it possible to compress the filter block 20 no later than when mounting on the vehicle, so that the filter block 20 is pre-stressed between the lower support 30 and the filter block. cover 40 The cover 40 can be made for example of rigid plastic material, if appropriate with reinforcements or inserts. The filter block cover 40 comprises a central portion 41 abutting an upper face 23 of the filter block 20, and a peripheral portion 42 surrounding the central portion 41 and abutting the annular peripheral portion 32 of the lower support 30. The filter block cover 40 furthermore has an outer protective skirt 49 located radially outside and at least partially opposite an external peripheral face 82 of the bearing support 80 to delimit a sealing zigzag 83 in order to protect the bearing 2.

An attachment between the cover 40 and support 30 is provided by fastening means ensuring the fastening of the cover 40 with the filter block lower support 30. In this first embodiment, the fastening means for securing the cover 40 with the filter block lower support 30 comprise flaps 50 for securely fastening the lower support 30 while projecting from the annular peripheral portion 32 of the lower support 30. These flaps 50 are distributed, and preferably regularly distributed, on the annular peripheral portion 32 of the support 30 and are six in number. These flaps 50 each have the shape of a hook and are configured to enter the fastening position in fastening orifices 60 of the cover 40. These fastening orifices 60 are located on the peripheral portion 42 of the cover 40 and are associated with the flap 50 securing the lower support 30. More precisely, in the fastening position these fastening orifices 60 are passed through by a proximal portion 51 of the associated fastening flap 50 in an axial direction. Each flap 50 further has a distal portion 52 of the associated fastening flap 50 extending at least along a component perpendicular to the axial direction and which overlaps with a mating surface on one side of the cover 40 opposite the peripheral portion 32 of the lower support 30 to ensure, despite a prestressed force of the filter block 20, the securing of the cover 40 with the lower support 30 of the filter block.

The filtering sub-assembly 10 further comprises a lock washer 90. This lock washer 90 is here metallic, formed from a stamped sheet. In an assembly position, the cover 40 is located axially between the lock washer 90 and lower support 30, pairs of flaps 50 and notches 96 being formed on the lock washer 90 and lower support 30. It should be noted that according to a variant not shown here, a configuration could be obtained wherein the lower support 30 is located axially between the lock washer 90 and the cover 40.

The attachment of the cover 40 to the lower support 30 is achieved by the mating of the fastening flaps 50 with the notches 96, in the manner of a bayonet fastening. Indeed, the assembly of the filtering sub-assembly 10 is provided according to a mechanical sequence of suitable movements.

In particular, the filtering sub-assembly 10 comprises a plurality of fastening flaps 50 configured to cooperate with associated notches 96. Each of the flaps 50 of the lock washer is secured to either the lock washer 90 or the second element while the notches 96 are formed on the other of the lock washer 90 and the second element. In this way, cooperation of each of the fastening flaps 50 with an associated notch 96 allows the two elements to be assembled together, the first of those elements being either the lower support 30 or the cover 40 being interposed between the lock washer 90 and the second of those elements either the lower support 30 or the cover 40.

The cooperation of the fastening flaps 50 with the associated notches 96 makes it possible to ensure at least one axial locking of the filtering sub-assembly 10, the rotational locking being ensured by specially-adapted resilient locking means.

In this embodiment, each of the flaps 50 is formed on the lower support 30 and is associated with one of the notches 96, formed on the lock washer 90. The filtering sub-assembly 10 thus comprises as many fastening flaps 50 as notches 96.

In a first step, during assembly, the cover 40 is positioned so as to be axially between the lock washer 90 and the lower support 30. The lock washer 90 and lower support 30 are movable relative to each other between a relative approach position and a relative interpenetration position. This movement is obtained by a relative translational movement between the lock washer 90 and lower support 30 along the reference axis A1 in such a way that, in the relative interpenetration position, each of the fastening flaps 50 penetrates the associated notch 96.

In a second step, to finalize the assembly and once the relative interpenetration position is attained, the lock washer 90 and lower support 30 are movable relative to each other between the relative interpenetration position and a relative assembly position. This movement is obtained by a relative rotational movement between the lock washer 90 and filter block lower support 30 around the reference axis A1 in such a way that in the relative assembly position, each of the flaps 50 is housed in a circumferential extension of the associated notch 96 and therein retained axially abutting a rim of the associated notch.

The notches 96 can take various forms. However, they each have a first part 961 extending parallel to the reference axis A1 and whose opening is configured in its sizing to be crossed by an axial template of the flap 50, and a second portion 962 of the notch 96 extending circumferentially relative to the reference axis A1 of the filtering sub-assembly 10 from the first part 961.

During the movement of the relative approach position to the relative interpenetration position, the distal portion 52 of each flap 50 forming a hook head is moved axially through a fastening orifice 60 associated with the fastening flap 50 of the lower support 30 then through the first part 961 associated with each of the notches 96. In the interpenetration position, the proximal part 51 of each fastening flap 50 forming a hook base is placed through the first part 961 associated with each of the notches 96.

Then, during the movement from the relative interpenetration position to the relative assembly position, the proximal portion 51 of each flap 50 is rotated and becomes housed in the circumferential extension 962 of the associated notch 96 with reduced cross-section relative to the template of each fastening flap 50 and in particular the template of each associated distal portion 52. The reduced cross-section of the circumferential extension forming the second part 962 of the notch 96 relative to the first part 961 provides axial engagement for the distal portion 52 of the associated fastening flap 50. In this way, in the relative assembly position, the distal portion 52 of each associated fastening flap 50 extends at least along a component perpendicular to the axial direction and overlaps with an associated mating surface on the cover side 40 opposite the peripheral portion 32 of the lower support 30.

The mating surface is here carried by the lock washer 90 such that each fastening flap 50 is retained axially by the lock washer 90 in the relative assembly position, thus ensuring the fastening of the cover 40 to the filter block lower support 30.

Of course, the fastening orifices 60 of the cover 40 are sized to not constrain this rotational movement when the filtering sub-assembly 10 moves from the relative interpenetration position to the relative assembly position, the peripheral portion 42 of the cover 40 carrying the fastening openings 60 being located axially between the annular peripheral portion 32 of the lower support 30 and the lock washer 90.

The filtering sub-assembly 10 further comprises rotational locking means 59 of the relative assembly position so as to avoid reverse rotation. In this embodiment, the rotational locking means 59 are integral with the part not bearing the fastening flaps 50, namely the cover 40.

These rotational locking means 59 comprise at least one resilient blade, preferably a plurality of resilient blades, and preferably as many resilient blades as flaps 50.

Each of the resilient blades is positioned circumferentially adjacent one of the fastening flaps 50, and extends from a base to a blade head extending circumferentially and along an axial component so as to be axially protruding, on the side of the associated flap 50. At the same time, the flap axially penetrates the fastening orifice 60 the cover 40 then in the notches 96, each associated blade extending circumferentially from a circumferential edge of said corresponding fastening orifice 60 also penetrates the associated notch 96 so as to form an obstacle to the rotation of the lock washer 90 when it is in the relative assembly position. The blades are formed by stamping.

In the interpenetration position, each flap 50 penetrates the first part 961 of the associated notch 96, the resilient blade being constrained against a lower surface of the lock washer 90. During the rotational movement about the reference axis A1 from the interpenetration position to the relative assembly position, the proximal portion 51 of each flap 50 is rotated and is housed in the second part 962 of the notch 96 releasing into the first part 961 of the notch 96 a surface wherein the resilient blade comes to face in the relative assembly position and whose resilient release places the corresponding blade into the space defined by the first part 961 of the notch 96. In this position, the heads of each locking blade 59 form an obstacle in the associated notches 96 and are each placed in the thickness of the lock washer 90 to block any rotation that would tend to move it from the relative assembly position to the interpenetration position.

In the assembly method, during the step of moving from the relative approach position to the relative interpenetration position, the translation of the cover 40 and support 30 is such that the parts approach, the filter block 20 being located between these two parts. It is during this step that the filter block 20 is brought in compression by the cover 40 and the lower support 30, so that the filter block 20 is pre-stressed between the lower support 30 and the filter block cover 40. The relative rotation of the cover 40 and lower support 30 during the movement from the relative interpenetration position to the relative assembly position then makes it possible to axially lock the filtering sub-assembly 10 and the compressed position of the filter block 20 to ensure the prestress.

Thus, and generally, the filtering sub-assembly includes a first of either the lower support 30 and or cover 40 located axially between the lock washer 90 and a second of either the lower support 30 or the cover 40, flaps 50 and notches 96 being formed on the lock washer 90 and the second element, each of the fastening flaps 50 formed on a piece chosen from the lock washer 90 and the second element being associated with one of the notches 96, formed on another part of the lock washer 90 and the second element, the method for assembling the filtering sub-assembly 10 comprising at least the following steps:
moving from the relative approach position to the relative interpenetration position by relative translational movement between the first and the second element along the assembly axis A1 so as to make fastening flaps penetrate 50 into associated notches 96, each of the notches 96 being associated with either the first or second element and one of the fastening flaps 50 rigidly connected to the other of the first and second element,
moving from the relative interpenetration position and the relative assembly position by relative rotational movement between the first and the second element about the assembly axis A1 so that in the relative assembly position, each of the fastening flaps 50 is housed in a circumferential extension of the notch 96 associated with the relative interpenetration position and is retained axially therein to secure the cover 40 with the filter block lower support 30.

In the shown embodiment, the first element is the cover 40 and the second element is the lower support 30. However, in a variant not shown, the first element could be the support 30, and the second element would be the filter block cover 40. In this case, the annular portion 1031 of the body element 103 of the motor vehicle is clamped axially between the annular peripheral portion of the cover 40, and the lock washer 90.

In other variants also not shown, the fastening flaps 50 and the notches 96 can be distributed on both the first and second elements.

According to the embodiment, final assembly of the filtering sub-assembly 10 is carried out concomitantly with the fastening of said filtering sub-assembly 10 with a body element 103. To do this, a partial assembly of the filtering subassembly 10 is carried out beforehand, and held in place by radial interference between outer peripheral surfaces of the flaps 50 and inner peripheral surfaces of the fastening orifices 60 of the cover 40.

The fastening between the cover 40 and support 30 is provided independently of that of the filtering sub-assembly 10 to the body element 103 of the motor vehicle by virtue of fastening openings 44 arranged radially outside the bearing 2, and preferably outside the filter block lower support 30 (in the sense that in any axial plane passing through an opening 44 the lower support 30 is positioned between the reference axis A1 and the opening 44).

The cover 40 is suitable for fastening the top mount assembly 100 to the body 103 of the vehicle. It comprises for this purpose a plurality of fastening interfaces distributed over a perimeter of the cover 40, three of them being in this embodiment, but potentially more or fewer. Each of these fastening interfaces includes an opening 44, which in this embodiment is a tapped hole playing the functional role of a nut configured to receive a fastening screw, but may where appropriate be a hole to receive another fastening means, such as a rivet for example, or a screw/nut assembly. To ensure the rigid fastening of the fastening screws, the threaded interface serving as a nut is made of metal by an insert attached locally at each opening 44 in the plastic material of the cover 40.

The nuts forming the fastening elements are in this embodiment “T”-shaped as seen in cross-section, to maximize the structural strength of the nut embedded in the plastic material of the cover 40. Alternatively, fastening elements of different shapes can be envisaged, for example parallelepiped.

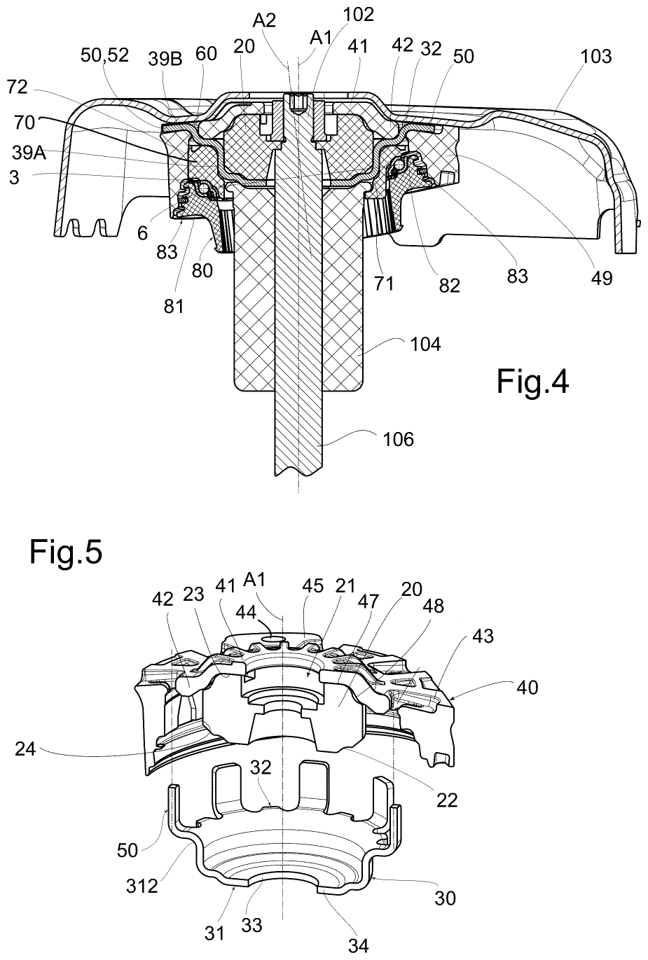

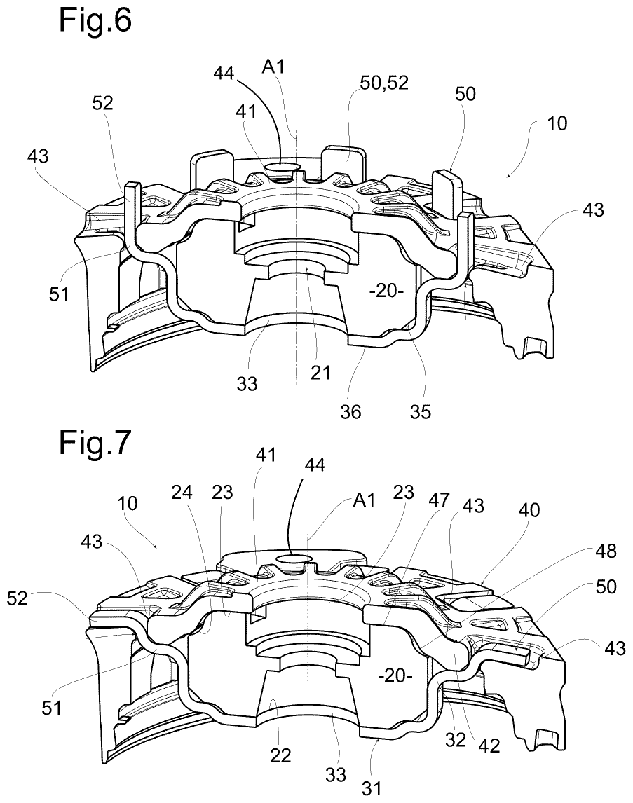

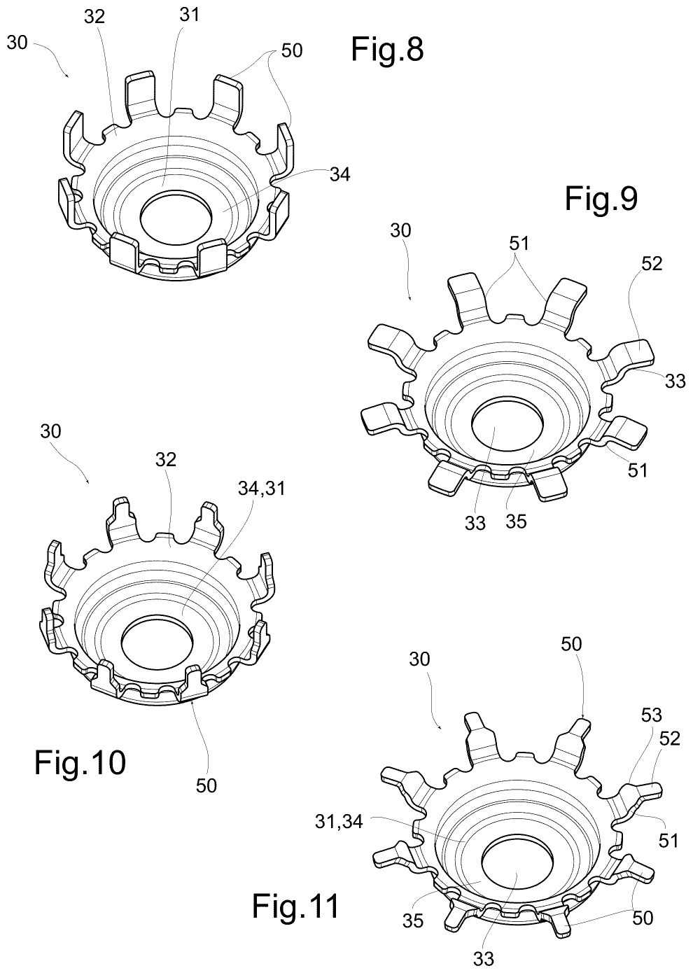

FIGS. 3 to 11 show a second embodiment. This second embodiment differs from the first embodiment essentially in that the fastening flaps 50 are no longer provided in order to be attached by following a sequence of particular movements, but rather are crimped against the cover 40 on the side of the cover 40 opposite the filter block 20 to secure the cover 40 to the filter block lower support 30.

In this embodiment also, the top mount assembly 100 of the motor vehicle suspension strut comprises, in the same way, a sliding or rolling bearing 2 defining a rotation axis A2 and the filtering sub-assembly 10 by abutting the bearing 2, this time indirectly.

This is because, in this second embodiment, the assembly 100 comprises a rigid intermediate support part 70 that abuts the bearing 2 and that forms a support cradle supporting the filtering sub-assembly 10. In particular, the filter block lower support 30 has a cylindrical skirt 39A configured to fit in an adjusted manner with a cylindrical portion 72, of the intermediate support part 70 of the assembly 100 and an outer transverse shoulder 39B to abut an upper face 73 of said intermediate support part 70 of the assembly 100.

The intermediate support part 70 is made from a single-piece plastic material, preferably without a metal insert, abuts the upper washer 5 of the bearing 2, and serves as a support for the annular single-piece lower support 30 of the filter block 20, so that it defines the relative positioning of the axis of revolution A1 of the lower support 30 of the filtering sub-assembly 10 from the rotation axis A2 of the bearing 2. Preferably, the upper face of the intermediate support part 70 which serves as a support for the lower support 30 of the filter block 20, and if applicable for the filter block cover 40, is produced without an undercut to allow axial demolding, along the same mold release axis coincident with the axis of rotational symmetry.

In the same way as the preceding embodiments, the assembly 100 comprises the annular bearing support 80 forming a direct or indirect mating face 81 for a coil spring 105 of the suspension, the mating face 81 facing axially away from the bearing 2.

Due to the presence of the intermediate part 70, the annular volume 3 for the bearing 2 is delimited at least in part between the intermediate support part 70 and the bearing support 80.

The intermediate support part 70 further comprises an inner skirt 71 positioned radially inside the bearing 2, the inner skirt 71 preferably comprising a hook shape for an upper end of the shock pad 104.

The filtering sub-assembly 10 further comprises fastening means ensuring the fastening of the cover 40 with the filter block lower support 30.

These fastening means always comprise fastening flaps 50 but obtained here by a crimping method.

More precisely, the filtering sub-assembly 10 comprises a plurality of fastening flaps 50, eight in the shown embodiment, distributed homogeneously over the annular peripheral portion 32 of the lower support 30. It will be noted that whatever the embodiment, the number of these flaps can vary. It is at least three flaps 50, preferably at least six flaps 50, and at most twelve flaps 50, preferably at most ten flaps 50. In this way, a reliable and simple assembly to be manufactured is maintained.

Each fastening flap 50 is crimped against the cover 40 on the side of the cover 40 opposite the filter block 20 to secure the cover 40 to the filter block lower support 30. Thus, fastening flaps are obtained whose distal portion 52 is bent relative to the proximal portion 51, this bending being formed by crimping.

The cover 40 comprises, for each fastening flap 50, a flap housing 43 configured to completely house at least the distal portion 52 of the associated fastening flap 50 in the cover 40 in the folded position. In a configuration, the filter block cover 40 has an upper bearing face 45 against a vehicle body element 103, which covers the filter block cover 40 by abutting it. Owing to the housings 43 of the fastening flaps 50, the filter block lower support 30 remains set back relative to this upper mating face 45.

The filter block cover 40 also comprises a peripheral portion 42 provided with fastening openings 44 positioned radially outside the bearing 2 and configured to directly or indirectly secure the filtering sub-assembly 10 to a body element 103 of the motor vehicle. The fastening openings 44 are independent here of the fastening orifices 60 associated with the fastening flaps 50 of the lower support 30. The filter block 20 is still pre-stressed here between the lower support 30 and the filter block cover 40.

The central portion 41 of the filter block cover 40 forms a bowl with a bottom 47 axially abutting the upper face 23 of the filter block 20 and an annular side wall 48, preferably cylindrical, conical or frustoconical, if necessary radially abutting a peripheral annular face 24 of the filter block 20. This radial pressure can be localized or even occasional and in particular allows self-centering relative to the reference axis A1.

Similarly, the lower support 30 also has an annular central portion 31 forming a bowl with a bottom 35 in axial abutment against the lower face 22 of the filter block 20 and an annular side wall, preferably cylindrical, radially abutting a peripheral annular face 24 of the filter block 20.

Thus, the method of assembling the filtering sub-assembly 10 comprises at least the following steps:
moving from the relative approach position to the relative interpenetration position by relative translational movement between the support 30 and the cover 40 along the assembly axis A1 so as to make fastening flaps penetrate 50 into the associated fastening orifices 60 of the cover 40 in the free position, before crimping, wherein the proximal 51 and distal 52 portions of each fastening flap 50 are substantially aligned in pairs along an axis parallel to the reference axis
moving from the relative interpenetration position to the relative assembly position by crimping each of the fastening flaps, each of the distal portions 52 of the associated fastening flap 50 becoming housed in the associated housing 43 of the cover 40 by being folded back against the mating surface carried by the cover 40, the cover 40 being retained axially to secure the cover 40 with the filter block lower support 30.

Of course, the invention is described in the foregoing by way of example. It is understood that a person skilled in the art is able to produce different variant embodiments of the invention without departing from the scope of the invention.

The shape of the notches may for example vary without modifying its function.

It is emphasized that all of the features, as they are taught to the person skilled in the art from the present disclosure, drawings and attached claims, even though specifically they have been described in relation to other determined features, both individually and in any combinations, may be combined with other features or feature groups disclosed herein, as long as not expressly excluded and no technical circumstances make such combinations impossible or nonsensical.

1. A top mount assembly of a motor vehicle suspension strut, the assembly comprising: a sliding or rolling bearing and a filtering sub-assembly in direct or indirect abutment against the bearing, the bearing defining an axis of rotation, the filtering sub-assembly comprising:
a filter block made of elastomeric material, the filter block extending along a reference axis and having an interface for securing one end of a rod of a damper of the suspension strut;
a filter block lower support located between the filter block and the bearing and having an annular central portion abutting a lower face of the filter block and traversed axially by a passage for the end of the rod of the damper, the filter block lower support having an annular peripheral portion surrounding the central portion, the filter block lower support further having an upper face facing the filter block and an opposing lower face for a shock pad of the suspension strut;
a filter block cover comprising a central portion abutting an upper face of the filter block, a peripheral portion surrounding the central portion and abutting the annular peripheral portion of the lower support, the peripheral portion of the filter block cover being provided with fastening openings arranged radially outside the bearing and configured to fasten the filtering sub-assembly to a body element of the motor vehicle; and
fastening means that secure the filter block cover to the filter block lower support independently of the fastening openings, the filter block being pre-stressed between the lower support and the filter block cover.

2. The top mount assembly of claim 1, wherein the filter block lower support has:
a cylindrical skirt configured to be fitted in an adjusted manner with a cylindrical portion of an intermediate support part or the bearing; and
an outer transverse shoulder to abut an upper face of said intermediate support part or the bearing.

3. The top mount assembly of claim 1, wherein the filter block lower support is made of a single piece of metal.

4. The top mount assembly of claim 1, wherein the filter block cover comprises a plastic material, without reinforcements or inserts.

5. The top mount assembly of claim 1, wherein the fastening means for securing the filter block cover with the filter block lower support comprise:
at least one flap for fastening the lower support protruding from the annular peripheral portion of the lower support; and
at least one fastening orifice on the peripheral portion of the filter block cover associated with the fastening flap of the lower support and crossed by a proximal portion of the associated fastening flap in an axial direction, a distal portion of the associated fastening flap extending at least along a component perpendicular to the axial direction overlapping with a mating surface on one side of the filter block cover opposite the peripheral portion of the lower support to ensure the fastening of the filter block cover with the lower support block support.

6. The top mount assembly of claim 1, wherein the fastening means for securing the filter block cover with the filter block lower support comprise at least one fastening per threading.

7. The top mount assembly of claim 1, wherein the peripheral portion surrounds the lower support.

8. The top mount assembly of claim 1, further comprising a rigid intermediate support part abutting the bearing and forming a support cradle supporting the filtering sub-assembly.

9. The top mount assembly of claim 1, further comprising an annular bearing support forming a mating face for a coil spring of the suspension strut, the mating face facing away from the bearing, the intermediate support part and the bearing support delimiting at least part of an annular volume for the bearing.

10. The top mount assembly of claim 1, wherein the filter block cover forms an outer protective skirt located radially outside and at least partially opposite an outer peripheral face of the bearing support to delimit a sealing zigzag.

11. The top mount assembly of claim 10, wherein the sealing zigzag provides a resilient attachment of cohesion between the bearing support and the filter block cover before mounting on the body element of the motor vehicle.

12. The top mount assembly of claim 8, wherein the intermediate support part or the bearing support comprises an inner skirt positioned radially inside the bearing.

13. The top mount assembly of claim 1, wherein the filter block cover comprises a plastic material with reinforcements or inserts.

14. The top mount assembly of claim 12, wherein the inner skirt comprises a hooking shape for an upper end of the shock pad.

15. A suspension strut for a motor vehicle, comprising a coil spring, a telescopic damper, a shock pad, and a top mount assembly comprising: a sliding or rolling bearing and a filtering sub-assembly in direct or indirect abutment against the bearing, the bearing defining an axis of rotation, the filtering sub-assembly comprising:
a filter block made of elastomeric material, the filter block extending along a reference axis and having an interface for securing one end of a rod of the telescopic damper;
a filter block lower support located between the filter block and the bearing and having an annular central portion abutting a lower face of the filter block and traversed axially by a passage for the end of the rod of the telescopic damper, the filter block lower support having an annular peripheral portion surrounding the central portion, the filter block lower support further having an upper face facing the filter block and an opposing lower face for the shock pad;
a filter block cover comprising a central portion abutting an upper face of the filter block, a peripheral portion surrounding the central portion and abutting the annular peripheral portion of the lower support, the peripheral portion of the filter block cover being provided with fastening openings arranged radially outside the bearing and configured to fasten the filtering sub-assembly to a body element of the motor vehicle; and
fastening means that secure the filter block cover to the filter block lower support independently of the fastening openings, the filter block being pre-stressed between the lower support and the filter block cover.
